(19) United States
(12) Patent Application Publication
(10) Pub. No.: US 2007/0157071 A1
(43) Pub. Date: Jul. 5, 2007

(54) Methods, systems, and computer program products for providing multi-media messages

(76) Inventor: William Daniell, Kennesaw, GA (US)

Correspondence Address: CANTOR COLBURN LLP - BELLSOUTH, 55 GRIFFIN ROAD SOUTH, BLOOMFIELD, CT, 06002, US

(21) Appl. No.: 11/324,124

(22) Filed: Jan. 3, 2006

(51) Int. Cl. G06F 15/00

(52) U.S. Cl. 715/500.1

(57) ABSTRACT

Methods, systems, and computer program products for providing multi-media messages. Methods include receiving multi-media content and a theme identifier. A template associated with the theme identifier is accessed. The template defines a display format for the multi-media content including a rich text format (RTF) document for containing the multi-media content. The multi-media content is transmitted to a user in the display format defined by the template.

### BACKGROUND

Exemplary embodiments relate generally to providing messages, and more particularly, to methods, systems and computer program products for providing multi-media messages.

Software is currently available to create video files and to transmit the video files across a network to another user. Typically, this is accomplished by creating a video file (e.g., at a video camera attached to a personal computer), saving the video file, and sending the video file as an attachment to an e-mail file. A user must be skilled with video software in order to create any special effects such as transitions between scenes and/or introductions or trailers. Also, using this approach of sending the video file as an e-mail attachment does not allow the user to specify a screen location for displaying the video file name (or first screen shot). Another approach is to save the video file on a storage device that is in communication with a network. Then, an e-mail message is sent that specifies a link to the video file. Again, this approach is not optimal because of the knowledge required to create special effects and the inability to specify screen placement. In addition, it requires the receiver to access the network in order to view the video file. It would be desirable to have a simplified manner of creating video e-mail messages that allows for video file placement and for easy customization of the video file. Further, it would be desirable to have a simplified manner of creating multi-media messages that allows for multi-media content placement and for easy customization of the multi-media content.

### SUMMARY

Exemplary embodiments relate to methods, systems and computer program products for providing multi-media messages. Methods include receiving multi-media content and a theme identifier. A template associated with the theme identifier is accessed. The template defines a display format for the multi-media content including a rich text format (RTF) document for containing the multi-media content. The multi-media content is transmitted to a user in the display format defined by the template.

Systems for providing multi-media messages include a processor and computer instructions executing on the processor. The computer instructions facilitate receiving multi-media content and a theme identifier. A template associated with the theme identifier is accessed. The template defines a display format for the multi-media content including a rich text format (RTF) document for containing the multi-media content. The multi-media content is transmitted to a user in the display format defined by the template.

Computer program products for providing multi-media messages include a storage medium readable by a processing circuit and storing instructions for execution by the processing circuit for facilitating a method. The method includes receiving multi-media content and a theme identifier. A template associated with the theme identifier is accessed. The template defines a display format for the multi-media content including a rich text format (RTF) document for containing the multi-media content. The multi-media content is transmitted to a user in the display format defined by the template.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 depicts an exemplary multi-media message that may be implemented by exemplary embodiments;

FIG. 2 is a flow diagram of a process for providing multi-media messages that may be implemented by exemplary embodiments;

FIG. 3 is a list of transition types that may be implemented by exemplary embodiments; and

FIG. 4 is a block diagram of an exemplary system that may be utilized to provide multi-media messages.

### DETAILED DESCRIPTION OF EXEMPLARY EMBODIMENTS

Exemplary embodiments are directed to providing a multi-media message comprised of a rich text format (RTF) document (e.g., a hyper text markup language (HTML) formatted text message) with multi-media content that a user can view (e.g., see, and/or listen) from a user system. In exemplary embodiments, the multi-media message is a video e-mail message comprised of a HTML formatted text message that a user can view from HTML supported e-mail clients (or user systems). In exemplary embodiments, the multi-media content is a video file and the video portion of the video e-mail message includes four parts: an introduction, a user message, a user supplied pre-recorded video, and a video trailer. Video e-mail clients utilize a theme definition to mix these videos into a single video to transmit to an e-mail recipient.

In exemplary embodiments, a theme is used to define how to mix video, bitmaps, audio, and RTF data to generate an electronic greeting card around a video clip recorded by a video e-mail client. A user records a video message and selects a greeting which defines an introduction clip and a trailing clip to the video. The introduction clip and/or trailing clip may include, for example, a holiday greeting, a personal greeting and/or a business greeting or any other kind of specialized introduction clips and/or trailing clips desired by the user. Different themes may be added based on the needs of the user. The theme may also define which transitions (e.g., a fader) will be used during the transition from, e.g., the introduction to the user message and/or from, e.g., the user message to the trailer. Transitions can be customized based on user needs. In addition, the theme defines the RTF document (e.g., an HTML document) that contains the video message to yield a final presentation such as the one depicted in FIG. 1.

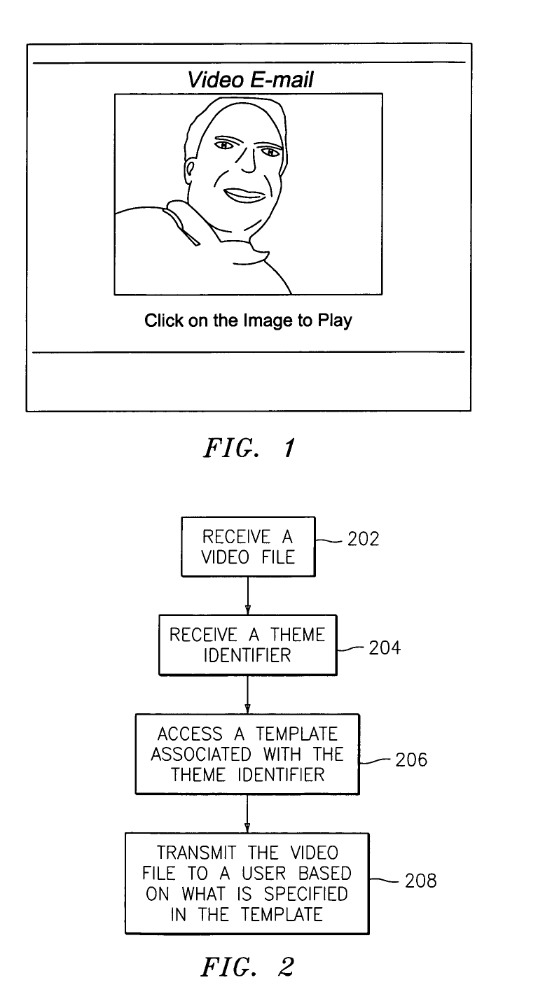

FIG. 2 depicts an exemplary process flow that may be implemented by exemplary embodiments. In exemplary embodiments, the processing in FIG. 2 is performed by a multi-media message application executing on a processor located on one or more of a host system and a client device, or user system. At block 202, the multi-media message application receives a video file from a user system where the video e-mail is being created. The video file may be created using, e.g., a video camera and/or microphone at the user system or it may be retrieved from a database of existing video files. In exemplary embodiments, the audio/video information is captured using a camera and microphone. In alternate exemplary embodiments, the combination of video only, audio only or audio/video information may be captured and/or generated by other means such as a video camera that records both video and audio information. At block 204, the multi-media message application receives a theme identifier from the user. According to an exemplary embodiment, the theme identifier is utilized as an index into a database of pre-defined templates. At block 206, a template associated with the theme identifier is accessed. At block 208, the video file is transmitted to a user based on what is specified in the selected template. In exemplary embodiments, the video file is transmitted to the user via an HTML supported e-mail client device in the format specified by the template.

In exemplary embodiments, the transmitting also includes transmitting the video file and the template via any method of transmitting digital data (e.g., via an e-mail message, an instant message or a multi-media message service (MMS)) to a user system. The user system contains all or portions of the multi-media message application for creating the video e-mail presentation to the user based on the contents of the template. In exemplary embodiments, the video file is presented within an HTML document. The user then initiates viewing the video file by selecting (i.e., “clicking on”) the video file within the HTML document. In exemplary embodiments, the video file includes one or both of audio and video data.

In exemplary embodiments, a theme is defined by an extensible markup language (XML) formatted text file (referred to herein as a template). Within the XML file, a theme is divided into sections that must be defined. These sections are “Page”, “Intro”, and “Ending”. The “Page” section describes the RTF page, such as where can the RTF file be found. The “Intro” section describes the video introduction that will be generated and mixed into the final video. The “Ending” section describes the video trailer that will be generated and mixed into the final video.

Following is a video e-mail theme XML file (template) that may be utilized by exemplary embodiments:

```
<?xml version=‘1.0’ encoding=‘utf-8’?>
<Theme name=’{Theme Name}’ category=‘{Theme Category}’>
    <Page directory=‘{Relative Directory Path}’
          file=’{HTML Filename}>
    </Page>
    <Intro type=‘{File Type}’
        file=‘{Intro Filename}’
        transition=’{Transition Type}’
        sound=’{Sound Filename}’
        duration=’{Duration in Seconds}’>
    </Intro>
    <Ending type=‘{File Type}’
          file=‘{Ending Filename}’
          transition=’{Transition Type}’
          sound=’{Sound Filename}’
          duration=’{Duration in Seconds}’>
    </Ending>
</Theme>
```

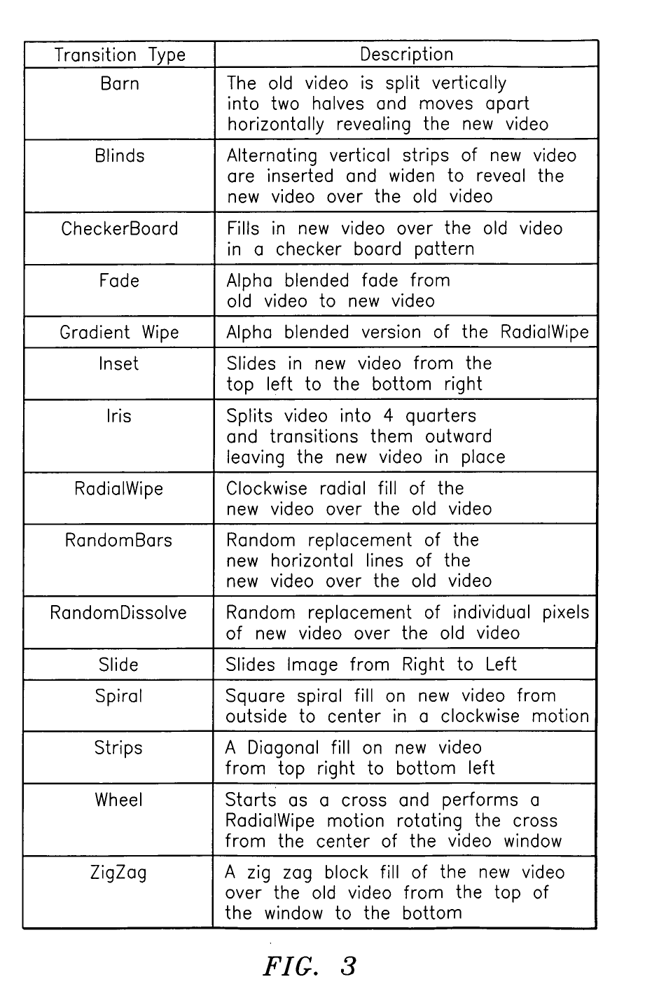

The theme name refers to the name (referred to herein as the theme identifier) that the user will use to identify a video e-mail theme. The theme category is the category that will be used to classify a theme type and can be utilized by the user to filter specific themes. The relative directory path is the path relative to the root theme directory. The file type is used to determine the type of file that is supplied for an introduction or trailer. In exemplary embodiments, the file type is video or bitmap. The “intro filename” or “ending file name” is the name of the file imported and used during the mixing of the rendering of either the video introduction or the video trailer. The transition type is used to select the video transition type to use during the transition from the introduction to the video message or from the video message to the trailer. A video transition type is defined as a transition from one video/audio clip to another. One example of this is a “video wipe/audio fade”, which would cause the video transition from “clip a” to “clip b” in a clockwise circular pattern while fading out audio from “clip a” and fading in audio from “clip b.” A typical video transition lasts about four seconds (but may be longer or shorter in length). See FIG. 3 for a list of transition types that may be implemented by exemplary embodiments.

In exemplary embodiments, a setup wizard may be executed at a client device to collect information about equipment and software located on the client device (e.g., camera information and microphone information). The wizard requests video information by providing a pull-down list of available sources. In exemplary embodiments, the wizard asks the user to verify that the video is working. Additionally, the user can adjust video parameters using DirectX provided dialogs. The wizard will also request audio information. Again, it is in the form of a pull-down list of valid sources and the wizard asks the user to verify that the audio is working. Additionally, the user has the ability to adjust audio volume.

In exemplary embodiments, a window interface may be provided for user systems that will be utilized to create multi-media messages. An exemplary window interface will include a user interface with the following:

The window will have a toolbar

File

| | |
|---|---|
| Send Message | Alt + S |
| Save Message | Ctrl + S |
| Print | Ctrl + P |
| Close | |

Edit

| | |
|---|---|
| Cut | Ctrl + X |
| Copy | Ctrl + C |
| Paste | Ctrl + V |
| Select All | Ctrl + A |

Message

| | |
|---|---|
| Check Spelling | F7 |
| Select Recipients | |
| Set Priority | |

Tools

| | |
|---|---|
| Address Book | Ctrl + Shift + B |

Help

| | |
|---|---|
| Contents and Index | F1 |

The window will have a toolbar
Send
Preview
Select Theme
Add Video

The window will have a “To:” line

The window will have a “Cc:” line

The window will have a “Subject” line

The body of the email will show capture or a preview of the captured video

The body of the email will contain a toolbar
Record
Stop
Pause
Play
Delete

Exemplary embodiments support the transmitting of any multi-media content within an RTF formatted document such as, but not limited to, video files, audio files, still image files and files containing any combination of video, audio and still images. In addition, exemplary embodiments support any RTF formatted document for containing the multi-media content including, but not limited to, HTML documents and MicroSoft Word documents. Further, exemplary embodiments support the transmission of the multi-media content to a user via any digital transmission means such as, but not limited to, instant messaging, MMS and/or an e-mail message.

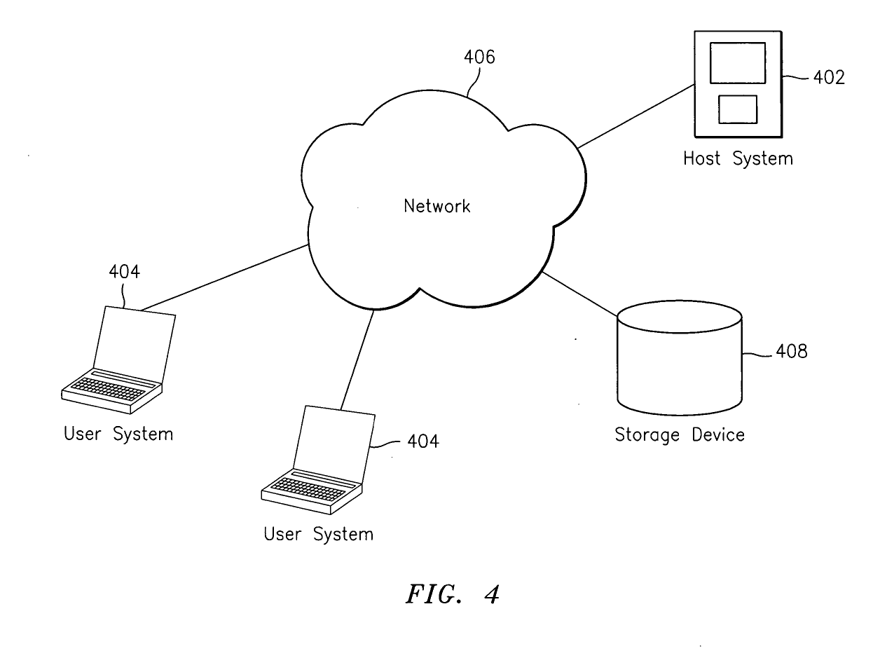

FIG. 4 is a block diagram of an exemplary system that may be utilized to provide multi-media messages. The system depicted in FIG. 4 includes one or more user systems 404, through which users at one or more geographic locations may contact the host system 402 to access the multi-media message application. The user systems 404 may be utilized to create multi-media messages and to receive multi-media messages. In order to create multi-media messages, a user system 404 executes the multi-media message application via instructions and data located on the user system 404 and/or a host system 402. In exemplary embodiments, the user systems 404 are RTF supported clients that execute a web browser. In addition, the user system 404 may optionally include a microphone, camera, and/or video camera for use in creating multi-media content. The host system 402 executes computer instructions for creating multi-media messages in response to user requests. The user systems 404 are coupled to the host system 402 via a network 406. Each user system 404 may be implemented using a general-purpose computer executing a computer program for carrying out the processes described herein. The user systems 404 may be implemented by personal computers and/or host attached terminals. If the user systems 404 are personal computers (e.g., laptop, cellular telephone, personal digital assistant), the processing described herein may be shared by a user system 404 and the host system 402 (e.g., by providing an applet to the user system).

The network 406 may be any type of known network including, but not limited to, a wide area network (WAN), a local area network (LAN), a global network (e.g. Internet, cellular), a virtual private network (VPN), and an intranet. The network 406 may be implemented using a wireless network or any kind of physical network implementation. A user system 404 may be coupled to the host system through multiple networks (e.g., intranet and Internet) so that not all user systems 404 are coupled to the host system 402 through the same network. One or more of the user systems 404 and the host system 402 may be connected to the network 406 in a wireless fashion.

The storage device 408 includes the templates and multi-media content and any other data relating to providing multi-media messages. The storage device 408 may be implemented using a variety of devices for storing electronic information. It is understood that the storage device 408 may be implemented using memory contained in the host system 402, a user system 404, or it may be a separate physical device. The storage device 408 is logically addressable as a consolidated data source across a distributed environment that includes a network 406. Information stored in the storage device 408 may be retrieved and manipulated via the host system 402 and/or via one or more user systems 404. In exemplary embodiments, the host system 402 operates as a database server and coordinates access to multi-media message data including data stored on the storage device 408.

The host system 402 depicted in FIG. 4 may be implemented using one or more servers operating in response to a computer program stored in a storage medium accessible by the server. The host system 402 may operate as a network server (e.g., a web server) to communicate with the user systems 404. The host system 402 handles sending and receiving information to and from the user system 404 and can perform associated tasks. The host system 402 may also include a firewall to prevent unauthorized access to the host system 402 and enforce any limitations on authorized access. A firewall may be implemented using conventional hardware and/or software in a manner those skilled in the art would appreciate.

The host system 402 may also operate as an application server. The host system 402 executes one or more computer programs to perform the processing described herein (e.g., the multi-media message application and the installation wizard). Processing may be shared by the user system 404 and the host system 402 by providing an application (e.g., java applet) to the user system 404.

Alternatively, the user system 404 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

Exemplary embodiments provide an easy to use method of composing multi-media messages. Exemplary embodiments allow a multi-media message creator to create a multi-media message quickly by selecting multi-media content and a template associated with a theme. The template is utilized to format the multi-media message including placement of the multi-media content. The ease of use provided by exemplary embodiments may result in an increased use of multi-media messages.

As described above, embodiments may be in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing exemplary embodiments. When implemented on a general-purpose microprocessor, the computer program code segments configure the microprocessor to create specific logic circuits.

While exemplary embodiments of the invention have been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

What is claimed is:

1. A method for providing multi-media messages the method comprising:
receiving multi-media content;
receiving a theme identifier;
accessing a template associated with the theme identifier, the template defining a display format for the multi-media content including a rich text format (RTF) document for containing the multi-media content; and
transmitting the multi-media content to a user in the display format defined by the template.

2. The method of claim 1, wherein the transmitting includes transmitting the multi-media content and the template to the user via an e-mail message.

3. The method of claim 1, wherein the RTF is hyper text format language (HTML).

4. The method of claim 1, wherein the user initiates viewing the multi-media content by selecting the multi-media content on a user system display.

5. The method of claim 1 wherein the display format for the multi-media content further includes an introduction to be played before the multi-media content and a trailer to be played after the multi-media content.

6. The method of claim 5 wherein the display format for the multi-media content further includes a transition between the introduction and the multi-media content and a transition between the multi-media content and the trailer.

7. The method of claim 1 wherein the theme identifier indicates a holiday.

8. The method of claim 1 wherein the multi-media content includes one or more of audio data, video data and still image data.

9. The method of claim 1 wherein the multi-media content is created and the theme identifier is selected by a second user accessing a user system.

10. The method of claim 9 wherein the theme identifier is selected by the second user from a plurality of theme identifiers each associated with a template.

11. A system for providing multi-media messages, the system comprising:
a processor; and
computer instructions executing on the processor for facilitating:
receiving multi-media content;
receiving a theme identifier;
accessing a template associated with the theme identifier, the template defining a display format for the multi-media content including a RTF document for containing the multi-media content; and
transmitting the multi-media content to a user in the display format defined by the template.

12. The system of claim 11, wherein the transmitting includes transmitting the multi-media content and the template to the user via an e-mail message.

13. The system of claim 11, wherein the RTF is HTML.

14. The system of claim 11, wherein the user initiates viewing the multi-media content by selecting the multi-media content on a user system display.

15. The system of claim 11, wherein the display format for the multi-media content further includes an introduction to be played before the multi-media content and a trailer to be played after multi-media content.

16. The system of claim 11, wherein the display format for the multi-media content further includes a transition between the introduction and the multi-media content and a transition between the multi-media content and the trailer.

17. The system of claim 11, wherein the multi-media content includes one or more of audio data, video data, and still image data.

18. The system of claim 11, wherein the multi-media content is created and the theme identifier is selected by a second user accessing a user system.

19. A computer program product for providing multi-media messages, the computer program product comprising a storage medium readable by a processing circuit and storing instructions for execution by the processing circuit for facilitating a method comprising:
receiving multi-media content;
receiving a theme identifier;
accessing a template associated with the theme identifier, the template defining a display format for the multi-media content including a RTF document for containing the multi-media content; and
transmitting the multi-media content to a user in the display format defined by the template.

20. The computer program product of claim 19 wherein the transmitting includes transmitting the multi-media content and the template to the user via an e-mail message.
